(19) United States
(12) Patent Application Publication
(10) Pub. No.: US 2026/0231146 A1
(43) Pub. Date: Aug. 6, 2026

(54) DEVICES, METHODS, APPARATUSES AND COMPUTER READABLE MEDIA FOR PROCESSING UPLINK TRANSMISSION FAILURE

(71) Applicant: Nokia Technologies Oy, Espoo (FI)

(72) Inventors: Ping YUAN, Beijing (CN); Ping Ping WEN, Shanghai (CN); Jing Yuan SUN, Beijing (CN)

(21) Appl. No.: 19/152,051

(22) PCT Filed: Feb. 14, 2023
(86) PCT No.: PCT/CN2023/075816

§ 371 Date: Jul. 30, 2025

(51) Int. Cl. H04W 72/1268; H04W 36/00

(52) U.S. Cl. CPC H04W 72/1268; H04W 36/0072

(57) ABSTRACT

Various example embodiments relate to devices, methods, apparatuses and computer readable media for processing uplink transmission failure. An example terminal device may be configured to receive from a network device, an uplink grant for scheduling transmission of a plurality of uplink repetitions, determine whether at least part of the scheduled uplink repetitions fulfill a timing constraint for timing advance adjustment and uplink processing delay, and transmit the at least part of the scheduled uplink repetitions in a case where the at least part of the scheduled uplink repetitions fulfills the timing constraint.

### TECHNICAL FIELD

Various example embodiments described herein generally relate to communication technologies, and more particularly, to devices, methods, apparatuses and computer readable media for processing uplink (UL) transmission failure.

### BACKGROUND

Certain abbreviations that may be found in the description and/or in the figures are herewith defined as follows:
3GPP 3rd Generation Partnership Project
CE Control Element
DCI Downlink Control Information
eMTC enhanced Machine-Type Communication
HARQ Hybrid Automatic Repeat reQuest
IoT Internet of Things
MAC Medium Access Control
NB-IoT Narrow Band Internet of Things
NR New Radio
NTN Non-Terrestrial Network
RAN Radio Access Network
RRC Radio Resource Control
SIB System Information Block
TA Timing Advance
TB Transport Block
UE User Equipment

3GPP has developed support for Internet of Things (IoT), including for example Narrow Band Internet of Things (NB-IoT) and enhanced Machine-Type Communication (eMTC), over a Non-Terrestrial Network (NTN) where a satellite constellation including one or more low earth orbit satellites may be deployed to communicate with user equipments (UEs) on the ground. The satellite may be implemented as a radio repeater to relay communications between UEs and base stations on the ground, or it may include a base station onboard. The NTN can extend IoT services to places without terrestrial infrastructures.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a terminal device is provided. The terminal device may comprise at least one processor and at least one memory storing instructions. The instructions may, when executed by the at least one processor, cause the terminal device at least to receive from a network device, an uplink grant for scheduling transmission of a plurality of uplink repetitions, determine whether at least part of the scheduled uplink repetitions fulfill a timing constraint for timing advance adjustment and uplink processing delay, and transmit the at least part of the scheduled uplink repetitions in a case where the at least part of the scheduled uplink repetitions fulfills the timing constraint.

In a second aspect, an example embodiment of a network device is provided. The network device may comprise at least one processor and at least one memory storing instructions. The instructions may, when executed by the at least one processor, cause the network device at least to transmit to a terminal device, an uplink grant for scheduling transmission of a plurality of uplink repetitions, and receive from the terminal device, a part of the scheduled uplink repetitions.

In a third aspect, an example embodiment of a method is provided. The method may comprise receiving an uplink grant for scheduling transmission of a plurality of uplink repetitions, determining whether at least part of the scheduled uplink repetitions fulfill a timing constraint for timing advance adjustment and uplink processing delay, and transmitting the at least part of the scheduled uplink repetitions in a case where the at least part of the scheduled uplink repetitions fulfills the timing constraint.

In a fourth aspect, an example embodiment of a method is provided. The method may comprise transmitting an uplink grant for scheduling transmission of a plurality of uplink repetitions, and receiving a part of the scheduled uplink repetitions.

In a fifth aspect, an example embodiment of an apparatus is provided. The apparatus may comprise a first means for receiving an uplink grant for scheduling transmission of a plurality of uplink repetitions, a second means for determining whether at least part of the scheduled uplink repetitions fulfill a timing constraint for timing advance adjustment and uplink processing delay, and a third means for transmitting the at least part of the scheduled uplink repetitions in a case where the at least part of the scheduled uplink repetitions fulfills the timing constraint.

In a sixth aspect, an example embodiment of an apparatus is provided. The apparatus may comprise a first means for transmitting an uplink grant for scheduling transmission of a plurality of uplink repetitions, and a second means for receiving a part of the scheduled uplink repetitions.

In a seventh aspect, an example embodiment of a computer readable medium is provided. The computer readable medium may comprise instructions stored thereon, and the instructions may, when executed by an apparatus, cause the apparatus to perform at least the following: receiving an uplink grant for scheduling transmission of a plurality of uplink repetitions, determining whether at least part of the scheduled uplink repetitions fulfill a timing constraint for timing advance adjustment and uplink processing delay, and transmitting the at least part of the scheduled uplink repetitions in a case where the at least part of the scheduled uplink repetitions fulfills the timing constraint.

In an eighth aspect, an example embodiment of a computer readable medium is provided. The computer readable medium may comprise instructions stored thereon, and the instructions may, when executed by an apparatus, cause the apparatus to perform at least the following: transmitting an uplink grant for scheduling transmission of a plurality of uplink repetitions, and receiving a part of the scheduled uplink repetitions.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating an example communication network in which example embodiments of the present disclosure may be implemented.

FIG. 2 is a schematic diagram illustrating uplink (UL) transmission timing in a non-terrestrial network (NTN).

FIG. 3 is a schematic diagram illustrating an example of timing advance (TA) report failure.

FIG. 4 is a message flow diagram illustrating an example process where outdated UL transmission timing offset is used at UE due to TA report failure.

FIG. 5 is a schematic diagram illustrating part of UL transmissions not fulfilling a time restriction in the NTN.

FIG. 6 is a flowchart illustrating a process in accordance with an example embodiment of the present disclosure.

FIG. 7 is a flowchart illustrating a process in accordance with an example embodiment of the present disclosure.

FIG. 8 is a flowchart illustrating a process in accordance with an example embodiment of the present disclosure.

FIG. 9 is a flowchart illustrating a process in accordance with an example embodiment of the present disclosure.

FIG. 10 is a block diagram illustrating an apparatus in accordance with an example embodiment of the present disclosure.

FIG. 11 is a block diagram illustrating an apparatus in accordance with an example embodiment of the present disclosure.

FIG. 12 is a block diagram illustrating devices in a communication system in accordance with an example embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” may refer to a radio access network (RAN) device. The RAN device may include for example a base station that can provide cells or coverage, through which terminal devices can access the network or receive services. The base station may be implemented as an evolved node B (eNB), a next generation eNB (ng-eNB), a next generation node B (gNB), or a beyond 5G base station. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture. The base station may be deployed on the ground or in the sky, for example on a satellite, a high altitude platform station, an unmanned aircraft system, a balloon, an airplane, and/or the like.

As used herein, the term “terminal device” or “user equipment” (UE) may refer to any entities or devices that can wirelessly communicate with the network devices or with each other. Examples of the terminal device can include a mobile phone, a mobile terminal (MT), a mobile station (MS), a subscriber station (SS), a portable subscriber station (PSS), an access terminal (AT), a computer, a wearable device, an on-vehicle communication device, a machine type communication (MTC) device, a D2D communication device, a V2X communication device, a sensor and the like. The term “terminal device” can be used interchangeably with a UE, a user terminal, a mobile terminal, a mobile station, or a wireless device.

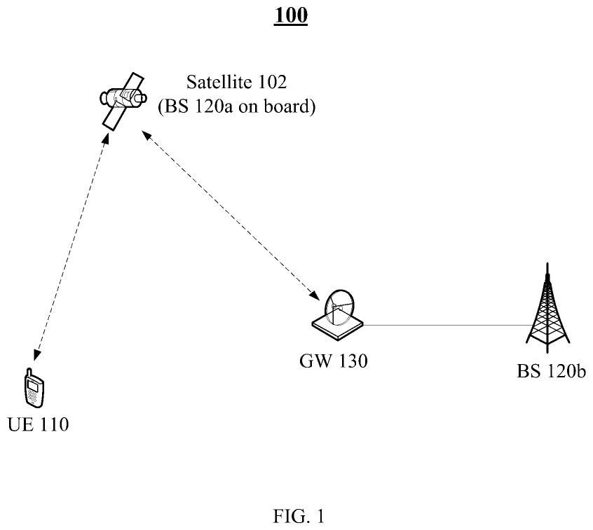

FIG. 1 is a schematic diagram illustrating an example communication network 100 in which example embodiments of the present disclosure may be implemented. The communication network 100 may form a part of a larger network e.g. a cellular communication network. Referring to FIG. 1, the communication network 100 may be implemented as a non-terrestrial network (NTN) including one or more user equipments (UEs) 110 (one is shown in FIG. 1) and one or more satellites 102 (one is shown in FIG. 1). The satellites 102 may include for example low Earth orbit (LEO) satellites, geostationary (GEO) satellites, and satellites in between GEO and LEO altitudes, or it may be replaced by e.g. an airplane, a balloon, a high altitude platform station, an unmanned aircraft system, etc.

The satellites 102 may be implemented as a regenerative satellite or a transparent satellite. The regenerative satellite may include at least part of a base station 120a to perform at least part of functionalities of the base station 120a. For example, if the satellite 102 includes a 5G New Radio (NR) base station 120a named gNB onboard, NR-Uu radio interface may be implemented on a service link between the satellite 102 and the UEs 110, and N2/N3 interface may be implemented on a feeder link between the satellite 102 and a gateway 130 on the ground. The gateway 130 may provide interconnections to terrestrial infrastructures including for example a base station 120b and/or a core network (not shown). The transparent satellite acts as an analogue radio frequency repeater to relay communications between the UEs 110 and the base station 120b on the ground (via the gateway 130). For example, if the base station 120b is implemented as a 5G NR base station named gNB, the transparent satellite may simply repeat NR-Uu radio interface on the feeder link and the service link. Additionally, the satellites 102 may also communicate with each other via an inter satellite link (ISL). With the satellites 102, the NTN 100 can extend network services to places without any terrestrial infrastructures.

As discussed above, in the NTN 100, the UEs 110 may communicate with the base station 120a deployed on the satellite 102 or the base station 120b deployed on the ground. For convenience of description, the base station 120a and the base station 120b may be collectively referred to as base stations 120 or individually as base station 120.

3GPP has agreed to support Internet of Things (IoT), including for example Narrow Band Internet of Things (NB-IoT) and enhanced Machine-Type Communication (eMTC), over the non-terrestrial network (NTN). Similar to the NR NTN, a Hybrid Automatic Repeat reQuest (HARQ) mechanism is also used in the IoT NTN to enhance communication reliability. An uplink (UL) HARQ process may be configured in Mode A or Mode B. In Mode A, HARQ UL retransmissions would rely on a decoding result of a previous UL transmission. If decoding of the previous UL transmission is failed, the network will schedule retransmissions on the UL HARQ process. If decoding of the previous UL transmission is successful, the network will schedule a new transmission on the UL HARQ process. It means that the UL HARQ process configured in Mode A cannot be reused until a round trip time (RTT) from when the network sends an UL grant to schedule the transmission to when the network receives the scheduled transmission from the UE (hereinafter BS-UE RTT) has passed. It may cause HARQ stalling due to the long BS-UE RTT since the distance between the base station and the UE is quite long in the NTN.

In Mode B, HARQ UL retransmissions may be blindly scheduled or no retransmission is scheduled at all. The network can schedule UL retransmissions before availability of previous transmission decoding result. It means that the UL HARQ process configured in Mode B can be reused without restriction of the BS-UE RTT. Hence it can avoid HARQ stalling since the HARQ process can be reused in time.

Since different HARQ modes may cause different HARQ transmission reliability and latency, logical channel prioritization (LCP) restriction on allowed HARQ mode in the NR NTN may be reused for the IoT NTN e.g. the eMTC NTN. For example, a logical channel (LCH) may be configured with a mapping rule that the LCH can be mapped to a HARQ process configured with HARQ Mode A, or a mapping rule that the LCH can be mapped to a HARQ process configured with HARQ Mode B. If an LCH is not configured with a mapping rule, it may be mapped to any HARQ process in Mode A or B. If UL HARQ mode is not configured, the LCH mapping rules may not be supported.

However, no LCP restriction is applied to UL medium access control control elements (MAC CEs) in the NTN. Then, the UL MAC CEs may be transmitted in a MAC protocol data unit (PDU) via a HARQ process either in Mode A or in Mode B.

An IoT UE, e.g. an eMTC UE (i.e., Bandwidth reduced Low complexity (BL) UE or UE in Coverage Enhancement (CE)), may report timing advance (TA) information to the network when the IoT UE is in a radio resource control (RRC) connected (RRC_CONNECTED) state and variation between the current TA and the last reported TA is larger than or equal to a threshold. The TA reporting threshold may be configured by the network for example via a parameter offsetThresholdTA. The TA report (TAR) may be indicated in a MAC Control Element (MAC CE). According to current MAC layer specification, all triggered TA reports shall be cancelled when a TAR MAC CE is included in a MAC PDU for transmission.

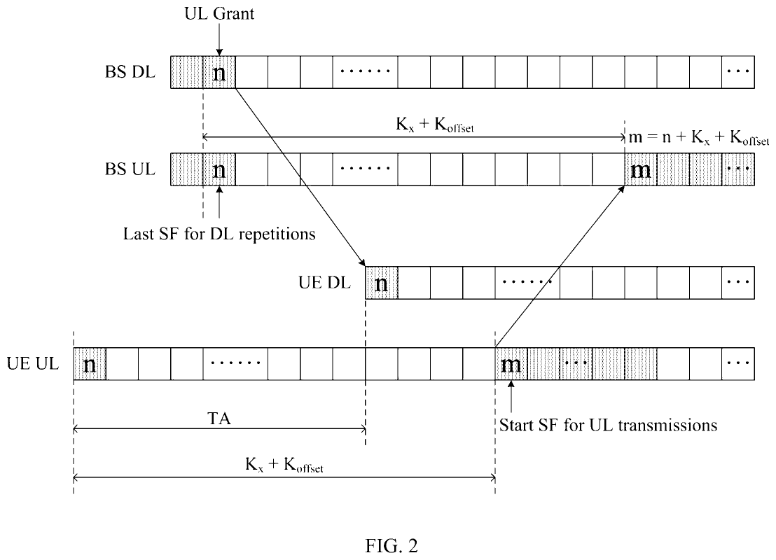

FIG. 2 is a schematic diagram illustrating uplink (UL) transmission timing for IoT NTN e.g. eMTC NTN, in which one box may represent one subframe or slot. Referring to FIG. 2, in response to for example a schedule request (SR) or a buffer state report (BSR) received from UE, the network may transmit an UL grant to UE in a subframe (or slot) n to schedule UL transmissions. The UL grant may be indicated in downlink control information (DCI) carried on for example a physical downlink control channel (PDCCH), an MTC physical downlink control channel (MPDCCH), or a narrowband physical downlink control channel (NPDCCH). In IoT NTN e.g. eMTC NTN, the UL transmissions would be delayed with an uplink transmission timing offset K_{offset}, as compared to UL transmissions scheduled in a terrestrial network (TN). For example, as shown in FIG. 2, when the UE receives the UL grant in the last subframe (or slot) n for a bundle of downlink (DL) repetitions, it would schedule and transmit UL transmissions starting from a subframe (or slot) m calculated as m=n+Kₓ+K_{offset} where Kₓ is a network configured delay or a predefined delay in 3GPP specifications and it may be expressed as for example but not limited to K₂. The uplink transmission timing offset K_{offset} is a result of a cell specific time offset K_{cell_offset} minus a UE specific time offset K_{UE_offset}, i.e. K_{offset}=K_{cell_offset}−K_{UE_offset}. The cell specific time offset K_{cell_offset} may be indicated for example in a system information block (SIB) broadcast by the network and it represents a rough value that applies to all UEs in a cell. The UE specific time offset K_{UE_offset} may be indicated by MAC CE and it represents a delta value that is applied on the top of the cell specific time offset K_{cell_offset}. With the reported Timing Advance (TA) from the UE, the network can configure the UE with a proper UE specific time offset K_{UE_offset} such that the uplink transmission timing offset K_{offset} is larger than but close to the BS-UE RTT, thereby reducing UL latency and improving scheduling efficiency.

To guarantee that the UE has sufficient time to prepare UL data for transmission, the timing of the scheduled UL transmission, i.e. n+Kₓ+K_{offset}, should be larger than the actual UL transmission time which the UE can apply, i.e., n+TA+ActULProcessingDelay where the parameter ActULProcessingDelay represents an actual UL processing delay of the UE. It can be derived that the uplink transmission timing offset K_{offset} configured by the network should satisfy a condition K_{offset}>TA+ActULProcessingDelay−Kₓ.

As discussed above, since the LCP restriction is not applicable to UL MAC CEs, the TAR MAC CE may be transmitted in a MAC PDU in either UL HARQ Mode A or B. For UL HARQ Mode B, however, the network may not decode the MAC PDU correctly because HARQ Mode B supports no UL retransmission and/or blind UL retransmission where the retransmission is not based on the decoding result of a previous UL transmission. Unlike data transmission where a radio link control (RLC) retransmission mechanism may be triggered for transmission robustness, there is no upper layer retransmission mechanism for MAC CEs. Furthermore, since the triggered TA report is cancelled at the UE when the TAR MAC CE is included in a MAC PDU, there is no chance for the UE to retransmit the TAR MAC CE, which means that the network will fail to obtain the latest TA if the TA report transmission is failed.

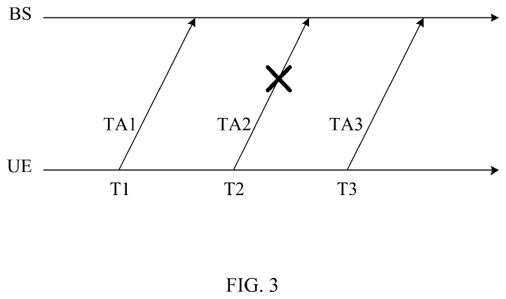

FIG. 3 is a schematic diagram illustrating an example of TA report transmission failure. Referring to FIG. 3, at T1, the UE may transmit current TA i.e. TA1 and the network i.e. the base station (BS) may successfully receive TA1. At T2, the UE finds that current TA (TA2) is threshold larger than the last reported TA (TA1) and it reports TA2 to the network, but the reported TA2 is not successfully obtained at the network. Then at T3 when the UE finds that current TA (TA3) is threshold larger than the last reported TA (TA2), the UE reports TA3 and the network successfully obtains the reported TA3. In this case, the network does not have a valid UE TA during T2 to T3 and has to use TA1 for scheduling UL transmissions. It is also possible that the reporting of TA3 also fails due to the invalid TA and/or other reasons and the time period when the network maintains the invalid TA will be longer. Therefore, the network may maintain outdated TA information if the TAR MAC CE is not transmitted to the network successfully, especially when the TAR MAC CE is transmitted in UL HARQ Mode B.

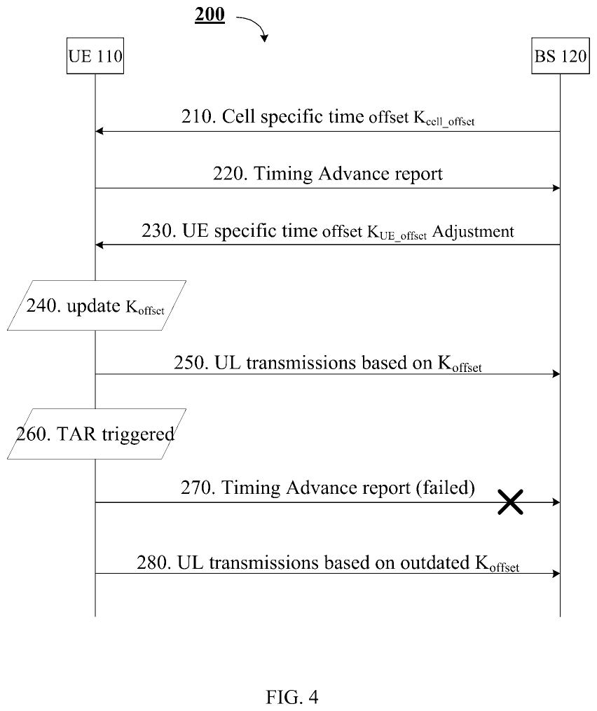

FIG. 4 is a message flow diagram illustrating an example process 200 where an outdated UL transmission timing offset K_{offset} is used at UE due to TA report failure. Referring to FIG. 4, at 210, the base station 120 may configure a cell specific time offset K_{cell_offset} via for example a system information block (SIB) for the UE 110. At 220, the UE 110 may transmit a TA report to the base station 120 when the UE 110 is in the RRC CONNECTED state. As mentioned above, the TA report may be transmitted by for example a MAC CE. Based on the received TA, the base station 120 may adjust a UE specific time offset K_{UE_offset} configured for the UE 110 at 230. With the adjusted UE specific time offset K_{UE_offset}, the UE 110 may update its UL transmission timing offset K_{offset} (i.e., K_{offset}=K_{cell_offset}−K_{UE_offset}) at 240. Then at 250, when the UE 110 receives an UL grant from the base station 120, the UE 110 may schedule and transmit UL transmissions based on the updated UL transmission timing offset K_{offset}.

As the UE 110 and/or the base station 120 (e.g., the base station 120a on the satellite 102) may move, a distance between the UE 110 and the base station 120 may change, causing a TA variation. When the UE 110 detects that a variation between the current TA and the last reported TA is larger than or equal to a threshold, the UE 110 may trigger a TA report event at 260 and send a new TA report to the base station 120 at 270. As mentioned above, the TA report may be carried by a TAR MAC CE. Here it is assumed that the base station 120 does not decode the TAR MAC CE successfully at 270. Accordingly, the base station 120 would not know whether the UE 110 was transmitting the TA report and hence it would not adjust the UE specific time offset K_{UE_offset} for the UE 110 based on the latest TA. As a result, the UE 110 has to use the outdated K_{offset} when it performs UL transmission at 280.

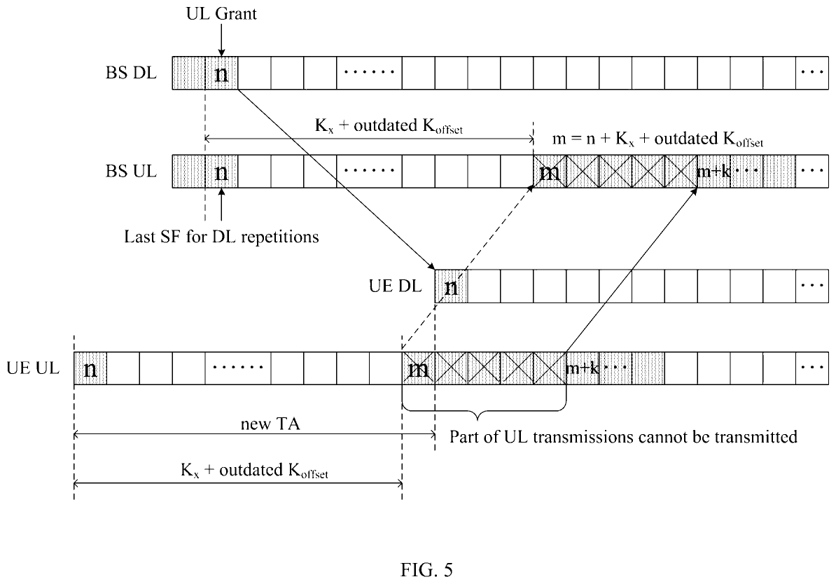

FIG. 5 illustrates an example of UL transmissions scheduled based on the outdated K_{offset}. Referring to FIG. 5, in response to an UL grant received in the last subframe (or slot) n for a bundle of DL repetitions, the UE 110 schedules UL transmissions starting from a subframe (or slot) m where m is calculated as m=(n+Kₓ+outdated K_{offset}). Since the current (new) TA becomes larger than the last reported TA that corresponds to the outdated K_{offset}, a part of the UL transmissions may be scheduled at subframes (or slots) before a time point determined by applying the new TA and the UE's UL processing delay (4 subframes/slots in the example shown in FIG. 5) and thus cannot be transmitted because the UE 110 does not have sufficient time to process and generate the UL PDUs for the part of UL transmissions. In the example shown in FIG. 5, the UE 110 does not have sufficient time to process and generate the part of UL transmissions scheduled at subframes (or slots) from m to mtk−1. Consequently, an UL transmission failure may occur for the part of UL transmissions due to insufficient time left for the part of UL transmissions.

Example embodiments of the present disclosure provide a solution for processing UL transmission failure caused by for example insufficient time left for the UL transmission. The example embodiments may be applied to IoT NTN including eMTC NTN and NB-IoT NTN, and to NR NTN where repetition is configured for UL transmissions.

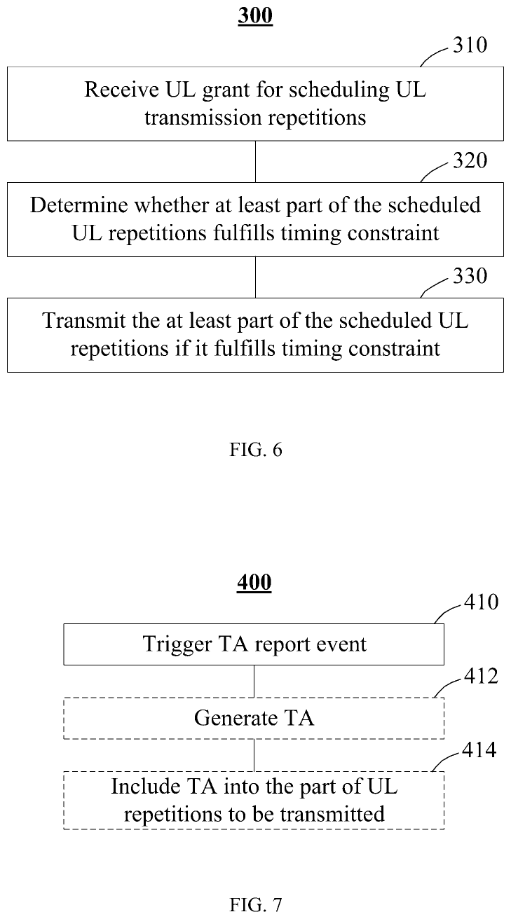

FIG. 6 is a flowchart illustrating a process 300 in accordance with an example embodiment of the present disclosure. The process 300 may be performed at UE like the UE 110 discussed above. In an example embodiment, the UE 110 may include a plurality of means, modules or elements for performing operations in the process 300. The means, modules and elements may be implemented in various manners including but not limited to for example software, hardware, firmware or any combination thereof.

As shown in FIG. 6, at 310, the UE 110 may receive an UL grant for scheduling UL transmissions from the base station 120. For example, when the UE 110 has UL data to be transmitted, it may transmit a scheduling request (SR) or a buffer state report (BSR) to the base station 120. In response to the SR or the BSR, the base station 120 may send the UL grant to the UE 110 to allocate UL resources for UL transmissions from the UE 110. The UL grant may be transmitted via downlink control information (DCI) carried on for example a physical downlink control channel (PDCCH) in NR NTN, an MTC physical downlink control channel (MPDCCH) in eMTC NTN, or a narrowband physical downlink control channel (NPDCCH) in NB-IoT NTN. Based on the received UL grant, the UE 110 may schedule UL transmissions on the allocated resources.

For example, referring to FIG. 5, it is assumed that the UE 110 receives the UL grant in a downlink (DL) subframe (or slot) n where the subframe n may be the last subframe for a bundle of DL repetitions. In response to the UL grant, the UE 110 may schedule UL transmission from an UL subframe (or slot) m where m may be calculated as m=n+Kₓ+K_{offset}. As mentioned above, Kₓ is the network configured UE processing delay or a predefined delay in 3GPP specifications and it may have a value for example 4 in Frequency Division Duplexing (FDD) or 6 or other values in Time Division Duplexing (TDD) depending on the TDD frame format. K_{offset} represents an UL transmission timing offset and it may be calculated as K_{offset}=K_{cell_offset}−K_{UE_offset} where K_{cell_offset} is a cell specific time offset and K_{UE_offset} is a UE specific time offset, both of which may be configured or indicated by the network. The scheduled UL transmissions may include a bundle of repetitions. That is, the same transport block (TB) is repeatedly transmitted in multiple consecutive subframes or slots. In eMTC NTN and NB-IoT NTN, the network may configure the number of repetitions for the UE 110 based on for example a coverage enhancement level desirable for the UE 110. In NR NTN, the network may configure the number of repetitions for the UE 110 based on for example radio quality between the UE 110 and the network. It would be appreciated that when the UE 110 schedules the UL transmissions based on the UL grant, the UE 110 may not know whether the UL transmission timing offset K_{offset} is valid or outdated.

At 320, the UE 110 may determine whether at least part of the scheduled UL repetitions fulfills a timing constraint for TA adjustment and UL processing delay. With continuous reference to FIG. 5, assuming N UL repetitions scheduled in subframes (or slots) m to m+N−1, the UE 110 may check whether at least part of the N UL repetitions fulfills the timing constraint expressed by the following formula:

$$TA + \leq ActULProcessingDelay \leq {K}_{x} + {K}_{offset} + k , where k = \{ 0 , … , N - 1 \} \qquad ( l )$$

As mentioned above, TA is the latest timing advance of the UE 110, ActULProcessingDelay is an actual UL processing delay of the UE 110 and it may be decided by UE implementation. The UE 110 can determine the smallest k value that satisfies the formula (1). If k=0 satisfies the formula (1), then all the N UL repetitions fulfill the timing constraint and can be transmitted as scheduled. If k=N−1 does not satisfy the formula (1), then all the N UL repetitions do not fulfill the timing constraint. If 0<k≤N−1 satisfies the formula (1), then the first k repetitions (subframes/slots m to m+k−1) do not fulfill the timing constraint, while the last (N−k) repetitions (subframes/slots m+k to m+N−1) fulfill the timing constraint. The UE 110 would have sufficient time to prepare and transmit the (N−k) repetitions.

If it is determined at 320 that at least part of the scheduled UL repetitions fulfills the timing constraint, the UE 110 may transmit the at least part of scheduled UL repetitions at 330. For example, as shown in FIG. 5, the UE 110 may transmit the (N−k) repetitions fulfilling the timing constraint starting from the subframe/slot m+k. If all the scheduled UL repetitions do not fulfill the timing constraint, the UE 110 may stop the UL transmission. In this case, the UE 110 may trigger a schedule request (SR) or a random access channel (RACH) procedure to inform the network that the scheduled UL transmission is failed.

If it is determined at 320 that a remaining part of the scheduled UL repetitions (e.g., the first k repetitions) does not fulfill the timing constraint, the UE 110 may drop the remaining part of the scheduled UL repetitions. Since the UL repetitions contain the same UL data, the network can still successfully receive the UL data from the part of the UL repetitions fulfilling the timing constraint and transmitted from the UE 110. Accordingly, the process 300 can increase the UL transmission reliability even only a part of the network scheduled repetitions can be transmitted. When the UE 110 drops the remaining part of the scheduled UL repetitions, it may drop slots or symbols allocated to the repetitions, or samples of the repetitions. In this case, the UE 110 may still transmit other UL transmissions in the subframes with slot/symbol/sample drop, thereby improving resource utilization.

In an example embodiment, when the remaining part of the scheduled UL repetitions that does not fulfill the timing constraint is dropped, the UE 110 may boost the transmit power for the part of repetitions fulfilling the timing constraint at 330 to increase the success chance of decoding the repetitions at the network.

In an example, the power ramp-up gain may be determined as (10*log₁₀(N/(N−k))+scaling factor)dB where the scaling factor may be configured by the network or predetermined or preconfigured at the UE 110.

In an example embodiment, the UE 110 may transmit the at least part of the scheduled UL repetitions that fulfills the timing constraint when the at least part of the scheduled UL repetitions further satisfies an additional condition for example a threshold. The threshold may be configured by the network. In an example, the configured threshold may comprise a number. When the number of repetitions fulfilling the timing constraint is higher than or equal to the threshold number, the repetitions fulfilling the timing constraint would be transmitted at 330. In another example, the configured threshold may comprise a percentage. When the percentage of the (N−k) repetitions fulfilling the timing constraint out of the total N repetitions is higher than or equal to the threshold percentage, the repetitions fulfilling the timing constraint would be transmitted at 330. If the repetitions fulfilling the timing constraint are less than the threshold number of percentage, the UE 110 may not transmit them at 330. For example, if less than 5% UL repetitions fulfill the timing constraint, it is highly likely that the network cannot decode the repetitions successfully even if they are transmitted at 330. Hence it can reduce transmission failure and save UE power by applying the threshold condition before transmitting the repetitions at 330.

In an example embodiment, the network may configure different thresholds for initial transmission and retransmissions. For example, the network may configure a first threshold for the initial transmission and a second threshold different from the first threshold for the retransmissions. If the scheduled UL repetitions are the initial transmission of the UL data, the first threshold would be applied as discussed above. If the scheduled UL repetitions are retransmission of the UL data, the second threshold would be applied. In an example, the threshold configured for the retransmissions may be lower than the threshold configured for the initial transmission because repetition can anyway provide gain for HARQ combination if the initial transmission is already failed.

FIG. 7 is a flowchart illustrating a process 400 in accordance with an example embodiment of the present disclosure. The process 400 may be implemented for example at the UE 110.

When the UE 110 determines at 320 in the process 300 that a part of the scheduled UL repetitions fulfills the timing constraint while a remaining part of the scheduled UL repetitions does not fulfill the timing constraint, the UE 110 may be aware of the fact that the parameter K_{offset} maintained at the UE 110 is outdated as compared to the latest TA of the UE 110. Then the UE 110 may trigger a TA report event at 410, even if the variation between the latest TA and the last reported TA is less than the threshold to trigger the TA report event.

In response to the triggered TA report event, the UE 110 may generate TA information including the latest TA of the UE 110 at 412. The UE may generate the TA information when the TA report event is triggered or when the UE has opportunity to perform UL transmission to include the information.

If the UE 110 determines to transmit the at least part of the scheduled UL repetitions at 330 and the scheduled UL repetitions are initial transmission, the UE 110 may include at 414 the generated TA information into the at least part of the scheduled UL repetitions for transmission at 330. In an example embodiment, the generated TA information may be indicated in a TAR MAC CE, and the UE 110 may prioritize the TAR MAC CE in a MAC layer logical channel prioritization (LCP) procedure to make sure that the TAR MAC CE would be included into a transport block (TB) to be transmitted in the at least part of the scheduled uplink repetitions. If the scheduled UL repetitions are retransmission, the UE 110 may not include the generated TA information into the at least part of the scheduled UL repetitions to be transmitted at 330 because the TB transmitted in the retransmission has to be identical to the TB transmitted in the initial transmission. Instead, the UE 110 may transmit the TA information to the network when additional UL resources are available. In another example embodiment, if the UE 110 decides not to transmit the at least part of the scheduled UL repetitions fulfilling the timing constraint for example because the at least part of the scheduled UL repetitions does not satisfy the network configured threshold, the UE 110 may transmit the TA report through for example a schedule request (SR) procedure or a random access channel (RACH) procedure.

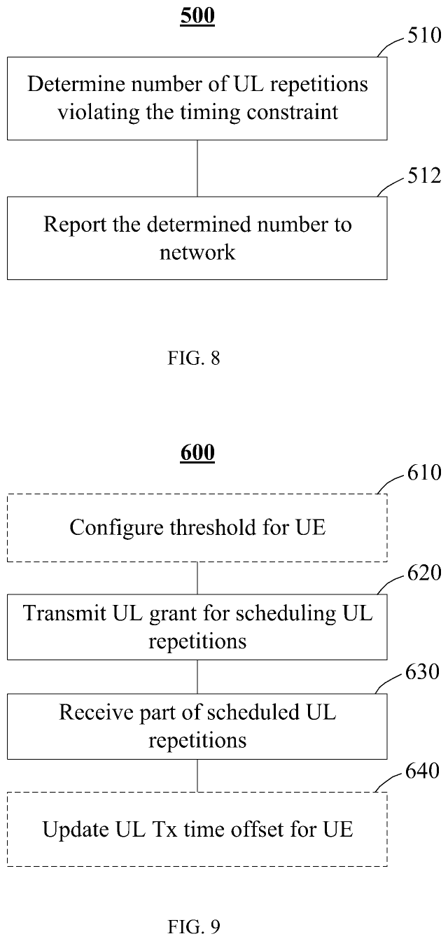

FIG. 8 is a flowchart illustrating a process 500 in accordance with an example embodiment of the present disclosure. The process 500 may be implemented for example at the UE 110.

Instead of triggering the TA report event at 410, the UE 110 may determine the number of UL repetitions not fulfilling the timing constraint at 510, when the UE 110 determines at 320 that a part of the scheduled UL repetitions fulfills the timing constraint while a remaining part of the scheduled UL repetitions does not fulfill the timing constraint. Then at 512, the UE 110 may report the determined number of the UL repetitions not fulfilling the timing constraint to the network. In an example embodiment, the determined number may be reported to the network by being included into the UL repetitions to be transmitted at 330, if the UL repetitions are initial transmission. For example, the number may be indicated in a MAC CE or as a part of a MAC PDU header, and the MAC CE or MAC PDU may be included into a TB to be transmitted in the UL repetitions. In this way, the network will know that the UE 110 is suffering from the UL transmission dropping and hence adjust the UL transmission timing offset K_{offset} (the cell specific time offset K_{cell_offset} and/or the UE specific time offset K_{UE_offset}) for the UE 110 based on the received number. The network may also adjust UL scheduling (for example, Kₓ) for the UE 110 to avoid the UL transmission dropping. If the scheduled UL repetitions are retransmission, the UE 110 may not include the determined number into the UL repetitions to be transmitted at 330 because the TB transmitted in the retransmission has to be identical to the TB transmitted in the initial transmission. Instead, the UE 110 may report the number to the network when additional UL resources are available.

FIG. 9 is a flowchart illustrating a process 600 in accordance with an example embodiment of the present disclosure. The process 600 may be performed at a base station like the base station 120 discussed above. In an example embodiment, the base station 120 may include a plurality of means, modules or elements for performing operations in the process 600. The means, modules and elements may be implemented in various manners including but not limited to for example software, hardware, firmware or any combination thereof. Since some details of the process 600 have been discussed above in description of the processes 300-500 relating to the UE 110, the process 600 will be described in a simple way here.

Referring to FIG. 9, at 610, the base station 120 may configure a threshold for the UE 110 to determine whether to transmit a part of scheduled UL repetitions when the part of the scheduled UL repetitions fulfills a timing constraint for TA adjustment and UL processing delay while a remaining part of the scheduled UL repetitions does not fulfill (i.e., violates) the timing constraint. As discussed above, the configured threshold may comprise a number or percentage of UL repetitions fulfilling the timing constraint, and the base station 120 may configure different thresholds for initial transmission and retransmission. In an example embodiment, the threshold(s) may be preconfigured or predetermined at the UE 110 and the step 610 may be omitted.

At 620, the base station 120 may transmit an UL grant to the UE 110 to schedule transmission of a bundle of UL repetitions.

At 630, the base station 120 may receive a part of the UL repetitions scheduled by the UL grant from the UE 110. For example, as discussed above, the UE 110 may transmit only a part of the scheduled UL repetitions because a remaining part of the scheduled UL repetitions does not fulfill the timing constraint for TA adjustment and UL processing delay.

In an example embodiment, the received part of the scheduled UL repetitions may include at least one of TA information or a number of UL repetitions scheduled by the UL grant and dropped at the UE 110. The TA information may contain the latest TA at the UE 110 and it may be indicated in a TAR MAC CE. The number of UL repetitions dropped at the UE 110 may be indicated in MAC CE or as a part of a MAC PDU header.

If the received UL repetitions contain at least one of the TA information and the number of UL repetitions dropped at the UE 110, then the base station 120 may update an UL transmission timing offset parameter K_{offset} (the cell specific time offset K_{cell_offset}, and/or the UE specific time offset K_{UE_offset}) configured for the UE 110 based on the received TA information or number of UL repetitions dropped at the UE 110 at 640. For example, the base station 120 may increase the UL transmission timing offset parameter K_{offset} configured for the UE 110 to avoid the UL repetition dropping.

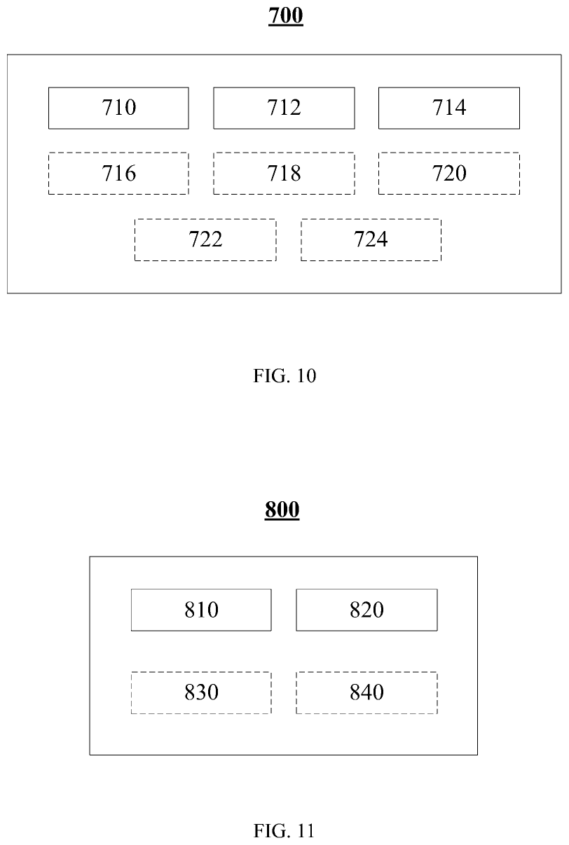

FIG. 10 is a block diagram illustrating an apparatus 700 in accordance with an example embodiment of the present disclosure. The apparatus 700 may be implemented to comprise or to form at least part of the UE 110 discussed above to perform at least part of operations related to the UE 110. Since the operations related to the UE 110 have been discussed above with reference to FIGS. 1-9, the blocks of the apparatus 700 will be described briefly here and details thereof may refer to the above description.

As shown in FIG. 10, the apparatus 700 may include a first means 710 for receiving from a base station an UL grant for scheduling transmission of a plurality of UL repetitions, a second means 712 for determining whether at least part of the scheduled UL repetitions fulfill a timing constraint for TA adjustment and UL processing delay, and a third means 714 for transmitting the at least part of the scheduled UL repetitions in a case where the at least part of the scheduled UL repetitions fulfills the timing constraint.

In an example embodiment, the at least part of the scheduled UL repetitions may be transmitted in a case where the at least part of the scheduled uplink repetitions further satisfies a threshold. The threshold may be configured by the base station and it may comprise a number or percentage of UL repetitions fulfilling the timing constraint. In an example embodiment, the threshold may comprise a first threshold configured for initial transmission and a second threshold configured for retransmissions.

In an example embodiment, the third means 714 may transmit the at least part of the scheduled UL repetitions with boosted power if a remaining part of the scheduled UL repetitions violates the timing constraint and is dropped. The remaining part of the scheduled uplink repetitions may be dropped in granularity of slot, symbol or sample.

In an example embodiment, the apparatus 700 may further comprise a fourth means 716 for triggering a TA report event in a case where a remaining part of the scheduled uplink repetitions violates the timing constraint, and a fifth means 718 for generating TA information in response to the TA report event. The TA information may contain the latest TA of the UE 110.

In an example embodiment, the apparatus 700 may further comprise a sixth means 720 for including the generated TA information into the at least part of the scheduled UL repetitions for transmission in a case where the scheduled UL repetitions are initial transmission. In an example, the generated TA information may be indicated in a TAR MAC CE, and the TAR MAC CE may be prioritized in a logical channel prioritization (LCP) procedure to make sure that the TAR MAC CE is included into a transport block (TB) to be transmitted in the at least part of the scheduled UL repetitions.

In an example embodiment, the apparatus 700 may further comprise a seventh means 722 for determining a number of UL repetitions included in a remaining part of the scheduled UL repetitions in a case where the remaining part of the scheduled UL repetitions violates the timing constraint, and an eighth means 724 for reporting the determined number to the base station. In a case where the scheduled UL repetitions are initial transmission, the eighth means 724 may report the determined number to the base station by including it into the at least part of the scheduled UL repetitions. For example, the determined number may be indicated in a MAC CE or as a part of a MAC PDU header, and the MAC CE or the MAC PDU may be included into a transport block (TB) to be transmitted in the at least part of the scheduled UL repetitions.

FIG. 11 is a block diagram illustrating an apparatus 800 in accordance with an example embodiment of the present disclosure. The apparatus 800 may be implemented to comprise or to form at least part of the base station 120 discussed above to perform at least part of operations related to the base station 120. Since the operations related to the base station 120 have been discussed above with reference to FIGS. 1-9, the blocks of the apparatus 800 will be described briefly here and details thereof may refer to the above description.

Referring to FIG. 11, the apparatus 800 may include a first means 810 for transmitting to the UE 110 an UL grant for scheduling transmission of a plurality of UL repetitions, and a second means 820 for receiving from the UE 110 a part of the scheduled UL repetitions. In an example embodiment, the received part of the scheduled UL repetitions may include at least one of TA information or a number of UL repetitions scheduled by the UL grant and dropped at the UE 110. The TA information may be indicated in a TAR MAC CE, and the number of UL repetitions is indicated in a MAC CE or as a part of a MAC PDU header.

In an example embodiment, the apparatus 800 may further comprise a third means 830 for updating an UL transmission timing offset parameter configured for the UE 110 based on the at least one of the TA information or the number of UL repetitions scheduled by the UL grant and dropped at the UE 110. In an example, the third means 830 may update the cell specific time offset K_{cell_offset} and/or the UE specific time offset K_{UE_offset} configured for the UE 110 based on the at least one of the TA information or the number of UL repetitions scheduled by the UL grant and dropped at the UE 110.

In an example embodiment, the apparatus 800 may further comprise a fourth means 840 for configuring a threshold for the UE 110 to determine whether to transmit the part of the scheduled UL repetitions in a case where the part of the scheduled UL repetitions fulfills a timing constraint for TA adjustment and UL processing delay while a remaining part of the scheduled UL repetitions violates the timing constraint. The threshold may comprise a number or percentage of UL repetitions fulfilling the timing constraint. In an example embodiment, the fourth means 840 may configure a first threshold for an initial transmission and a second threshold for retransmissions.

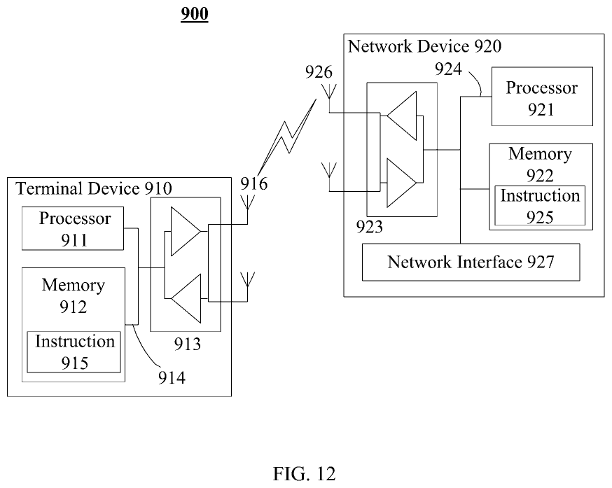

FIG. 12 is a block diagram illustrating devices in a communication system 900 in accordance with an example embodiment of the present disclosure. As shown in FIG. 12, the communication system 900 may comprise a terminal device 910 which may be implemented as the UE 110 discussed above and a network device 920 which may be implemented as the base station 120 discussed above.

Referring to FIG. 12, the terminal device 910 may comprise one or more processors 911, one or more memories 912 and one or more transceivers 913 interconnected through one or more buses 914. The one or more buses 914 may be address, data, or control buses, and may include any interconnection mechanism such as series of lines on a motherboard or integrated circuit, fiber, optics or other optical communication equipment, and the like. Each of the one or more transceivers 913 may comprise a receiver and a transmitter, which are connected to one or more antennas 916. The terminal device 910 may wirelessly communicate with the radio access network device 920 through the one or more antennas 916. The one or more memories 912 may include instructions 915 which, when executed by the one or more processors 911, may cause the terminal device 910 to perform operations and procedures relating to the UE 110 as described above.

The network device 920 may comprise one or more processors 921, one or more memories 922, one or more transceivers 923 and one or more network interfaces 927 interconnected through one or more buses 924. The one or more buses 924 may be address, data, or control buses, and may include any interconnection mechanism such as a series of lines on a motherboard or integrated circuit, fiber, optics or other optical communication equipment, and the like. Each of the one or more transceivers 923 may comprise a receiver and a transmitter, which are connected to one or more antennas 926. The network device 920 may operate as a base station for the terminal device 910 and wirelessly communicate with terminal device 910 through the one or more antennas 926. The one or more network interfaces 927 may provide wired or wireless communication links through which the network device 920 may communicate with other network devices, entities, elements or functions. For example, the network device 920 may communicate with a core network device (not shown) via backhaul connections. The one or more memories 922 may include instructions 925 which, when executed by the one or more processors 921, may cause the network device 920 to perform operations and procedures relating to the base station 120.

The one or more processors 911, 921 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 911, 921 may be configured to control other elements of the UE/radio access network device/core network device and operate in cooperation with them to implement the procedures discussed above.

The one or more memories 912, 922 may include at least one storage medium in various forms, such as a transitory memory and/or a non-transitory memory. The transitory memory may include, but not limited to, for example, a random access memory (RAM) or a cache. The non-transitory memory may include, but not limited to, for example, a read only memory (ROM), a hard disk, a flash memory, and the like. The term “non-transitory,” as used herein, is a limitation of the medium itself (i.e., tangible, not a signal) as opposed to a limitation on data storage persistency (e.g., RAM vs. ROM). Further, the one or more memories 912, 922 may include but not limited to an electric, a magnetic, an optical, an electromagnetic, an infrared, or a semiconductor system, apparatus, or device or any combination of the above.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some exemplary embodiments further provide program instruction or instructions which, when executed by one or more processors, may cause a device or apparatus to perform the procedures described above. The program instruction for carrying out procedures of the exemplary embodiments may be written in any combination of one or more programming languages. The program instruction may be provided to one or more processors or controllers of a general purpose computer, special purpose computer, or other programmable data processing apparatus, such that the program instruction, when executed by the processor or controller, cause the functions/operations specified in the flowcharts and/or block diagrams to be implemented. The program instruction may execute entirely on a machine, partly on the machine, as a stand-alone software package, partly on the machine and partly on a remote machine or entirely on the remote machine or server.

Some exemplary embodiments further provide a computer program product or a computer readable medium having the program instruction or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1. A terminal device comprising:
at least one processor; and
at least one memory storing instructions that, when executed by the at least one processor, cause the terminal device at least to:
receive from a network device, an uplink grant for scheduling transmission of a plurality of uplink repetitions;
determine whether at least part of the scheduled uplink repetitions fulfill a timing constraint for timing advance adjustment and uplink processing delay; and
transmit the at least part of the scheduled uplink repetitions in a case where the at least part of the scheduled uplink repetitions fulfills the timing constraint.

2. The terminal device of claim 1, wherein the at least part of the scheduled uplink repetitions is transmitted in a case where the at least part of the scheduled uplink repetitions further satisfies a threshold.

3. The terminal device of claim 2, wherein the threshold comprises a number or percentage of uplink repetitions fulfilling the timing constraint.

4. The terminal device of claim 2, wherein the threshold comprises a first threshold configured for an initial transmission and a second threshold configured for retransmissions.

5. The terminal device of claim 2, wherein the threshold is configured by the network device.

6. The terminal device of claim 1, wherein a remaining part of the scheduled uplink repetitions that violates the timing constraint is dropped.

7. The terminal device of claim 6, wherein the remaining part of the scheduled uplink repetitions is dropped in granularity of slot, symbol or sample.

8. The terminal device of claim 1, wherein the at least one memory further stores instructions that, when executed by the at least one processor, cause the terminal device at least to:
trigger a timing advance report event in a case where a remaining part of the scheduled uplink repetitions violates the timing constraint.

9. The terminal device of claim 8, wherein the at least one memory further stores instructions that, when executed by the at least one processor, cause the terminal device at least to:
generate timing advance information in response to the triggered timing advance report event; and
include the generated timing advance information into the at least part of the scheduled uplink repetitions for transmission in a case where the scheduled uplink repetitions are initial transmission.

10. The terminal device of claim 8, wherein the at least one memory further stores instructions that, when executed by the at least one processor, cause the terminal device at least to:
generate timing advance information in response to the triggered timing advance report event; and
include the generated timing advance information into the at least part of the scheduled uplink repetitions for transmission in a case where the scheduled uplink repetitions are initial transmission; and
wherein the generated timing advance information is indicated in a timing advance report medium access control control element, and the timing advance report medium access control control element is prioritized in a logical channel prioritization procedure to make the timing advance report medium access control control element be included into a transport block to be transmitted in the at least part of the scheduled uplink repetitions.

11. The terminal device of claim 1, wherein the at least one memory further stores instructions that, when executed by the at least one processor, cause the terminal device at least to:
determine a number of uplink repetitions included in a remaining part of the scheduled uplink repetitions in a case where the remaining part of the scheduled uplink repetitions violates the timing constraint; and
report the determined number to the network device.

12. The terminal device of claim 11, wherein, in a case where the scheduled uplink repetitions are initial transmission, the determined number is reported to the network device by being included into the at least part of the scheduled uplink repetitions.

13. The terminal device of claim 11, wherein, in a case where the scheduled uplink repetitions are initial transmission, the determined number is reported to the network device by being included into the at least part of the scheduled uplink repetitions; and
wherein the determined number is indicated in a medium access control control element or as a part of a header in a medium access control protocol data unit, and the medium access control control element or the medium access control protocol data unit is included into a transport block to be transmitted in the at least part of the scheduled uplink repetitions.

14. The terminal device of any claim 1, wherein, in a case where a remaining part of the scheduled uplink repetitions violates the timing constraint, the at least part of the scheduled uplink repetitions is transmitted with a boosted power.

15. A network device comprising:
at least one processor; and
at least one memory storing instructions that, when executed by the at least one processor, cause the network device at least to:
transmit to a terminal device, an uplink grant for scheduling transmission of a plurality of uplink repetitions; and
receive from the terminal device, a part of the scheduled uplink repetitions.

16. The network device of claim 15, wherein the received part of the scheduled uplink repetitions includes at least one of the following:
timing advance information, or
a number of uplink repetitions scheduled by the uplink grant and dropped at the terminal device.

17. The network device of claim 16, wherein the timing advance information is indicated in a timing advance report medium access control control element, or
the number of uplink repetitions is indicated in a medium access control control element or as a part of a header in a medium access control protocol data unit.

18. The network device of claim 16, wherein the at least one memory further stores instructions that, when executed by the at least one processor, cause the network device at least to:
update an uplink transmission timing offset parameter configured for the terminal device based on the at least one of the timing advance information or the number of uplink repetitions scheduled by the uplink grant and dropped at the terminal device.

19. The network device of claim 15, wherein the at least one memory further stores instructions that, when executed by the at least one processor, cause the network device at least to:
configure a threshold for the terminal device to determine whether to transmit the part of the scheduled uplink repetitions in a case where the part of the scheduled uplink repetitions fulfills a timing constraint for timing advance adjustment and uplink processing delay while a remaining part of the scheduled uplink repetitions violates the timing constraint.

20-21. (canceled)

22. A method comprising:
receiving, by a terminal device, an uplink grant for scheduling transmission of a plurality of uplink repetitions;
determining, by the terminal device, whether at least part of the scheduled uplink repetitions fulfill a timing constraint for timing advance adjustment and uplink processing delay; and
transmitting, by the terminal device, the at least part of the scheduled uplink repetitions in a case where the at least part of the scheduled uplink repetitions fulfills the timing constraint.

23-46. (canceled)
